(19) United States
(12) Patent Application Publication
(10) Pub. No.: US 2009/0058104 A1
(43) Pub. Date: Mar. 5, 2009

(54) DOOR OR WINDOW SAFETY MECHANISM

(76) Inventor: Yung-Chieh Huang, Zhonghe City (TW)

Correspondence Address: RABIN & BERDO, P.C., Suite 500, 1101 14 Street, N.W., Washington, DC, 20005, US

(21) Appl. No.: 11/846,714

(22) Filed: Aug. 29, 2007

(51) Int. Cl. E05C 19/18

(52) U.S. Cl. 292/288

(57) ABSTRACT

The invention relates to a door or window safety mechanism, mainly comprising a fixer and a door stop. The fixer is in an angular U shape to sandwich the lateral side of a door plank (window). The door stop comprises a stop body portion and a 90-degree bended upright-angled arm extending outwardly from the stop body portion; the end of the upright-angled arm and the fixer are fastened together. Upon application of the invention, the fixer simply sandwiches a door plank near a hinge on one lateral side of the door plank, in addition, the stop body portion of the door stop is bended toward the rear side direction of the fixer. When the door is opened, the stop body portion is sunk into a space between the door plank and the doorframe by means of the elasticity of the upright-angled arm to perform the anti finger pinch function and avoid the door plank to be closed.

### BACKGROUND OF THE INVENTION

I. Field of the Invention

The present invention relates to a door or window safety mechanism, especially to a door or window safety apparatus that is a simple structure with the advantages of easy installation and use without affect the looks. When a door is opened, a stop body portion of the invention is automatically arranged into the door gap between the door plank and doorframe, enabling a child to avoid anti finger pinch accident; when a user simply moves the stop body portion out of the door gap between the door plank and doorframe, the door is easily closed.

II. Description of the Prior Art

Generally, a conventional inward and outward opening door or window easily pinches a young child at the finger, therefore, it is necessary for each family with pre-school children at home or each classroom at elementary school to install such a door or window safety mechanism or apparatus.

At present, a similar door stop apparatus on the market (as shown on FIG. 1) comprises a base 10 and a door stop 20. The base is fastened on a doorframe and a shank 11 is perpendicularly arranged on the front side of the base. The shank 11 has a comparatively big globular portion 111 arranged on top thereof and a cross-shaped arresting portion 112 on bottom thereof positioned on the plane of the base; the door stop 20 is in a circular shape, having a cross-shaped opening 21 arranged on one side thereof corresponding to the position of the shank 11 on the base 10, thereby enabling said door stop to be positioned on the base 10. The drawbacks of said conventional structure lie in the followings. First, the base 10 is fixed on a doorframe 70 by screw(s) or viscose (as shown on FIG. 2), if the base is dismantled, the screw mark or viscose stain affects the overall looks of doorframe or doorframe, or the door stop 20 and the base 10 are easily loosened or apart when the door is constantly opened. Second, as the integration or the separation of the door stop 20 and the base 10 requires a user to press or pull out the shank of the base to change the direction of the door stop, in order to achieve the purpose of anti finger pinch, therefore, when a user integrates the door stop 20 and the base 10 together, he/she has to aim the cross-shaped opening at another cross-shaped arresting portion 112, or the door stop falls off on the ground. Consequently, said conventional door stop apparatus is inconvenient for use to reduce the practical effect. Third, if the strength of a user to press the door stop 20 is not properly controlled, the door stop 20 is easily loosened and fallen off when a young child is shaking the door plank, so as to cause accident.

Moreover, in accordance with U.S. Pat. No. 5,044,681, the door stop includes a “V” shaped body defined by a joinder line, with the “V” shaped body including an “L” shaped handle extending rearwardly of the body bisecting an acute included angle between the plates defining the body to permit positioning of the “L” shaped handle overlying the hinge when the plates are directed between the door and door frame to achieve the anti finger pinch effect. However, the prior art has to be removed when the door stop is unnecessary to use, therefore, a user easily mislay the prior art to reduce the practical functionality.

Consequently, said conventional structure is required to be improved.

### SUMMARY OF THE INVENTION

In view of the foregoing drawbacks of said conventional automobile driving warning equipment, an innovative “door or window safety mechanism” is therefore disclosed hereafter.

The main objective of the present invention is to provide a door or window safety mechanism with the advantages of simple to make at lower cost, easy to install and use.

To achieve said objectives, the door or window safety mechanism of the invention mainly comprises a fixer and a door stop; the characteristic of the invention lies in: said fixer is in an angular U shape enabling one lateral side of a door plank (casement) to be sandwiched therein, the door stop comprises a stop body portion and a 90-degree bended upright-angled arm extending outwardly from the stop body portion; the end of the upright-angled arm and the fixer are fastened together, in addition, the end of the upright-angled arm is the pivot for changing the position of the stop body portion.

To assemble the invention, a user applies the fixer to simply sandwich a door plank (window plate) near a hinge on one lateral side of the door plank window plate, in addition, bends the stop body portion of the door stop toward the rear side direction of the fixer. When the door window is opened, the stop body portion is sunk into a space between the door plank and the doorframe by means of the elasticity of the upright-angled arm to avoid the door plank to be closed; on the other hand, the door window is easily closed when a user removes the stop body portion from the space between the door plank and the doorframe.

### BRIEF DESCRIPTION OF THE DRAWINGS

FIG. 1 is a three-dimensional exploded view of a conventional structure;

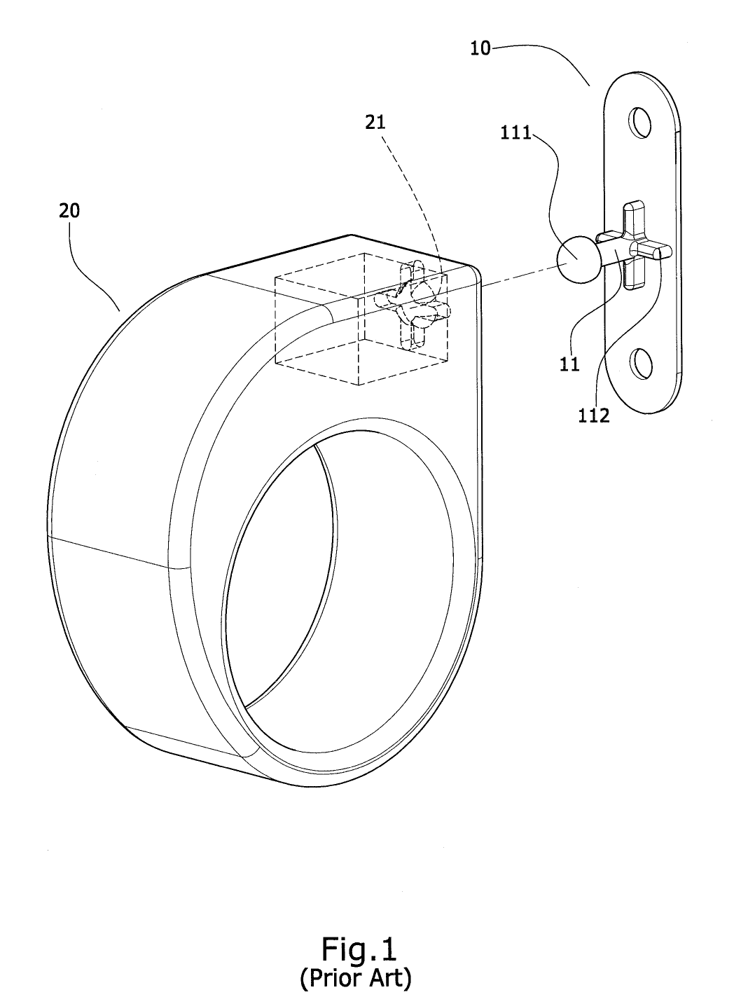

FIG. 2 is a schematic diagram showing the application of the conventional structure;

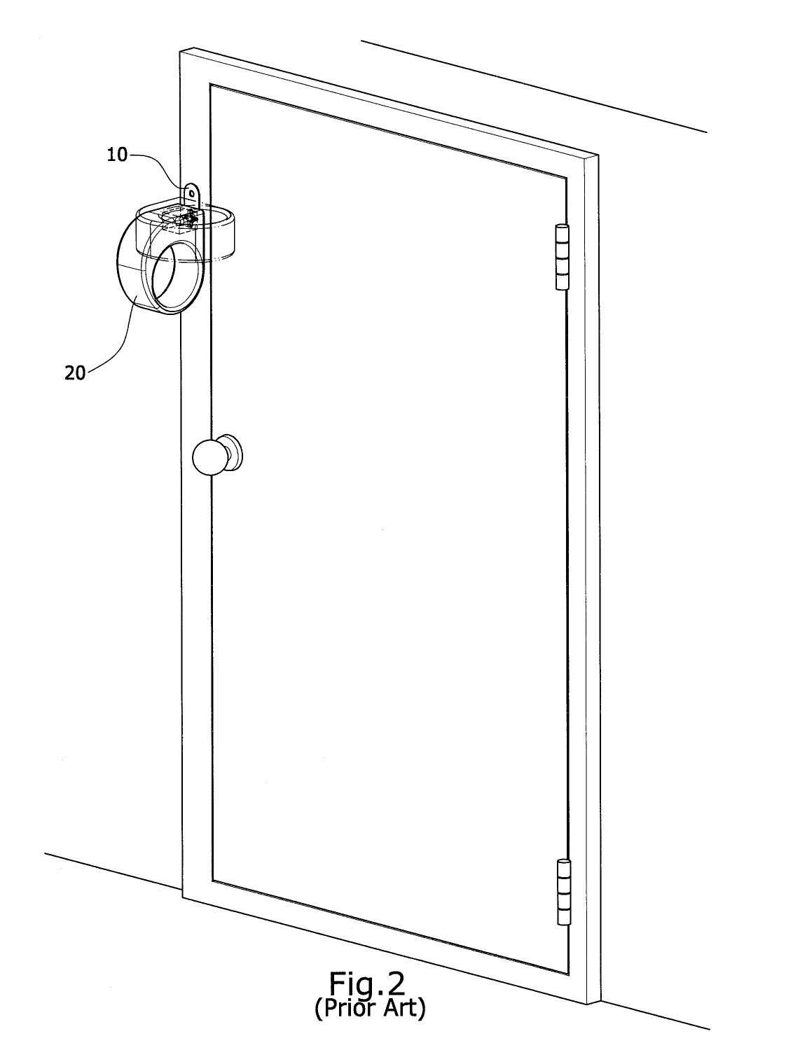

FIG. 3 is a three-dimensional exploded view showing a preferable embodiment (I) in accordance with the invention;

FIG. 4 is a three-dimensional diagram showing the application of the invention on FIG. 3;

FIGS. 5 and 6 are perspective views respectively showing enlargement of the invention on FIG. 3 in a state of anti finger pinch and in a removal state in accordance with the invention;

FIG. 7 is a three-dimensional exploded view showing another preferable embodiment (II) in accordance with the invention;

FIGS. 8 and 9 are perspective views respectively showing enlargement of the invention on FIG. 7 in a state of anti finger pinch and in a removal state in accordance with the invention;

FIG. 10 is a three-dimensional view showing another preferable embodiment (III) in accordance with the invention;

FIG. 11 is a three-dimensional view showing another preferable embodiment (IV) in accordance with the invention;

FIG. 12 is a perspective view showing the application of the invention on FIG. 10;

FIG. 13 is a three-dimensional view showing another preferable embodiment (V) in accordance with the invention;

FIG. 14 is a perspective view showing the application of the invention on FIG. 13; and

FIG. 15 is a perspective view showing another application of the invention on FIG. 13.

### DESCRIPTION OF THE PREFERRED EMBODIMENT

Further aspects, objects, and desirable features of the invention will be better understood from the detailed description and drawings that follow in which various embodiments of the disclosed invention are illustrated by way of examples.

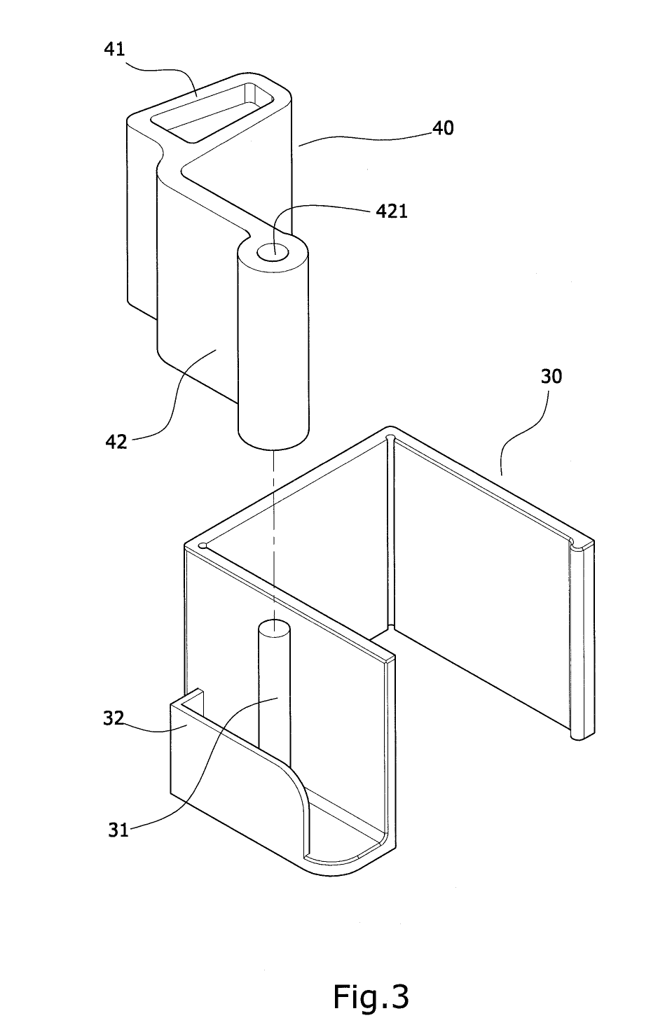

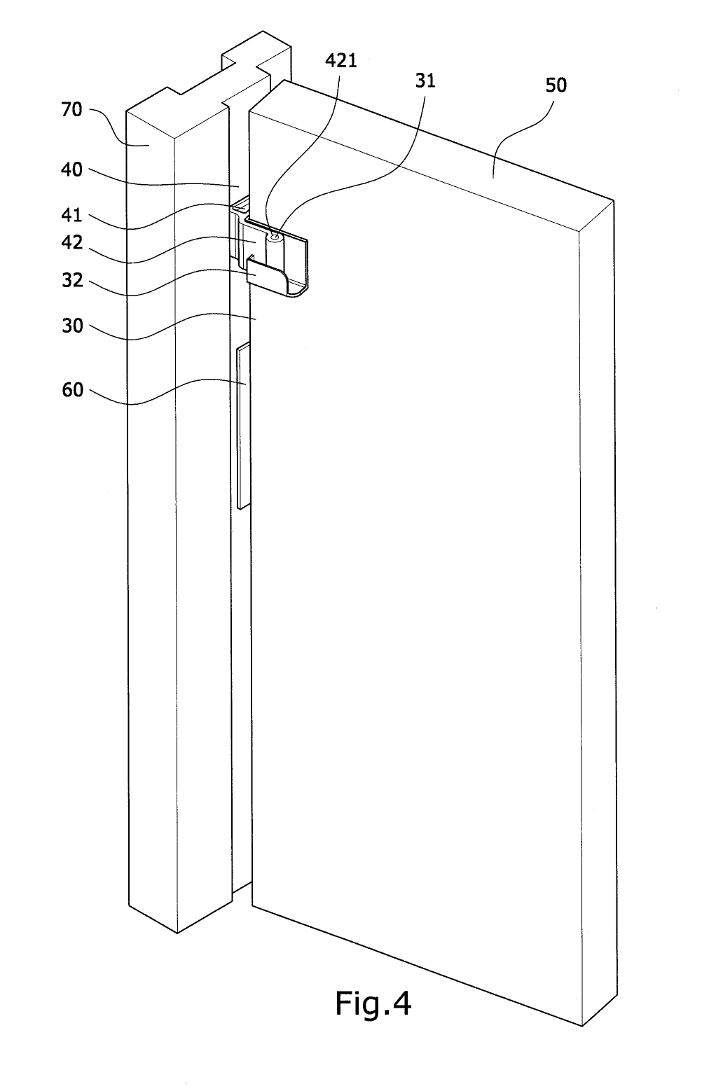

As shown in FIGS. 3 and 4 that a door or window safety mechanism of the invention mainly comprises a fixer 30 and a door stop 40; the characteristic lies in:

The fixer 30 is in an angular U shape, enabling the lateral side of a door plank (window) 50 to be sandwiched therein, the door stop 40 is made of either plastics (rubber) or metal material, comprising a stop body portion 41 and a upright-angled arm 42 extending (or bending 90-degree) outwardly from one lateral side of the stop body portion 41, the end of the upright-angled arm 42 and the fixer 30 are fastened together, in addition, the end of the upright-angled arm 42 is the pivot for changing the position of the stop body portion 41.

With reference to FIG. 3, a preferred embodiment shows that a upright shaft 31 is set on one lateral side of the angular U shaped fixer 30, both are parallel; in addition, a locating plate 32 is arranged on the outer lateral side of the upright shaft 31, a hole 421 is arranged on the end of the upright-angled arm 42 of the door stop 40 to sleeve the upright shaft 31 on the fixer 30 for integration.

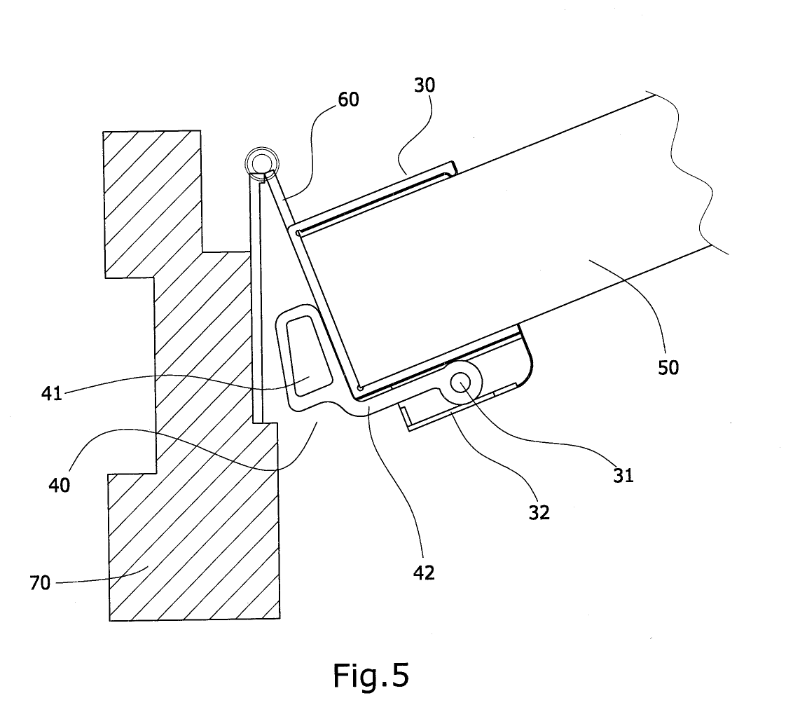

With reference to FIGS. 4 and 5, the fixer 30 is used to simply and easily sandwich a door plank (window) 50 near a hinge 60 on one lateral side of the door plank (window) 50, in addition, the stop body portion 41 of the door stop 40 is bended toward the rear side direction of the fixer 30 (i.e., between the door plank 50 and a doorframe 70, as shown on FIG. 5); accordingly, the invention is accommodated to prevent a child from finger pinch when the door plank 50 is closing; on the other hand, the door (window) is easily closed when a user changes side of the door stop 40 by enabling the stop body portion 41 to bend toward the outer lateral side of the fixer 30 (as shown on FIG. 6), so that the stop body portion 41 is not used to stop the close of the door plank 50.

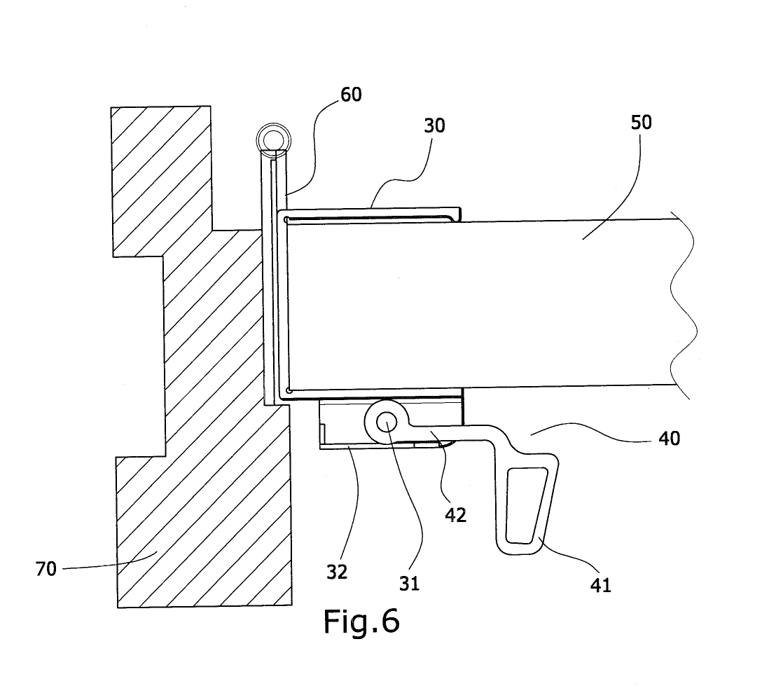

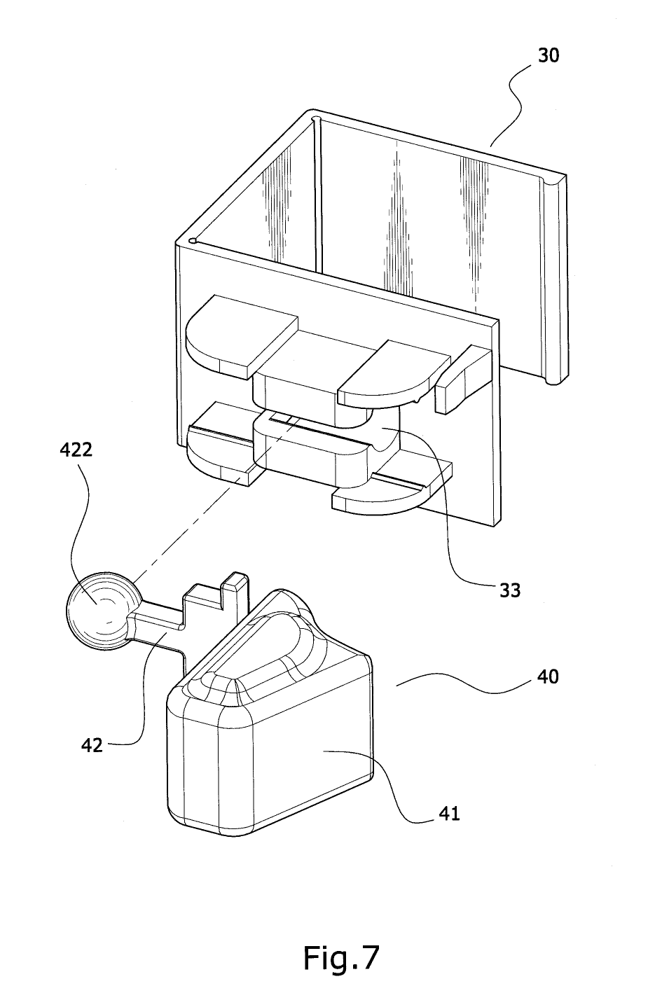

With reference to FIGS. 7 to 9, another embodiment of the invention shows that the fixer 30 has a round slot 33 set on one lateral side thereof, a globular portion 422 is set on the end of the upright-angled arm 42 of the door stop 40 to be accommodated in the round slot 33 of the fixer 30 for combination, in addition, the globular portion 422 is used as a pivot for changing the position of the stop body portion 41. Upon application of the invention, the stop body portion 41 of the door stop 40 is bended toward the direction on the rear side of the fixer 30 (as shown on FIG. 8) to perform the anti finger pinch function; when the stop body portion 41 of the door stop 40 is bended toward an outer lateral side fixer 30 near the opening thereof (as shown on FIG. 9), the anti finger pinch function of the invention is flexibly removed from the door.

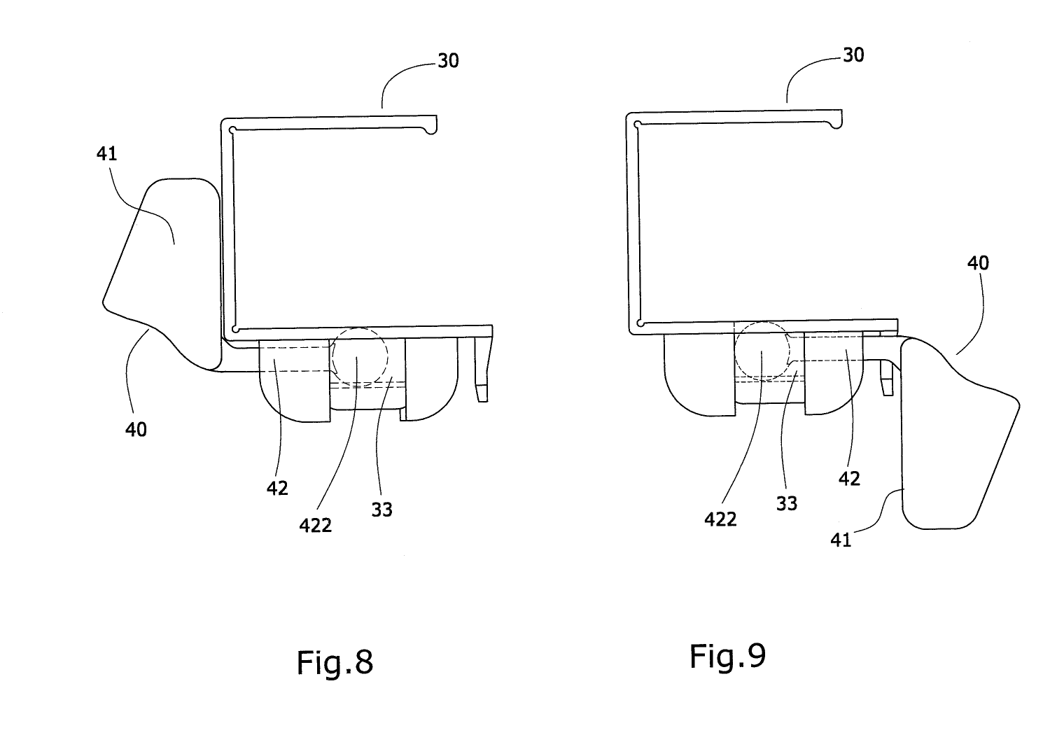

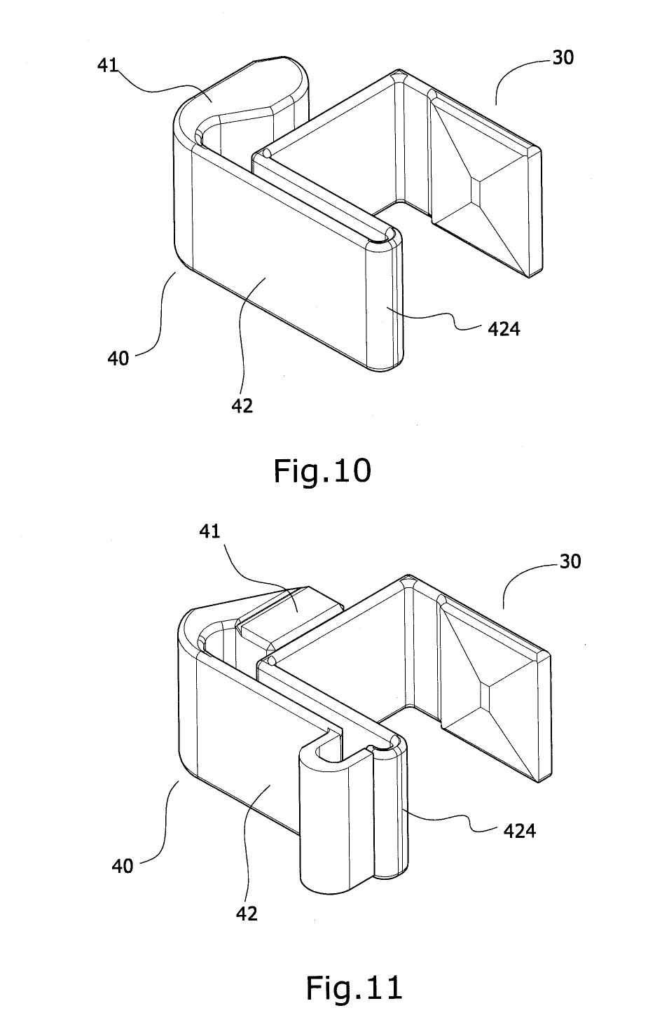

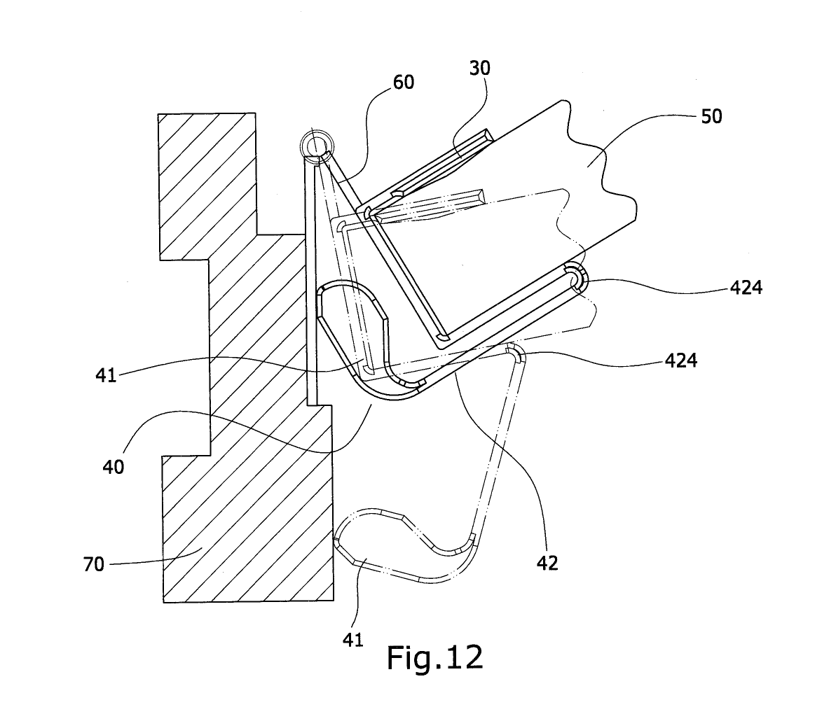

Moreover, with reference to another two embodiments of the invention as shown on FIGS. 10 and 11, one lateral side of the fixer 30 and the end of the upright-angled arm 42 of the door stop 40 are integrated in one piece, in addition, an elastic portion 424 is accommodated on the rear end of the upright-angled arm 42. Generally, the stop body portion 41 of the door stop 40 is in a state of bending to the rear lateral side of the fixer 30 (as shown on FIG. 10 or 11). Upon application of the invention that is accommodated on the rear lateral side of the door plank (window) 50, the stop body portion 41 remains in the space between the door plank 50 and the doorframe 70 to prevent the door plank 50 from being closed and to perform the anti finger pinch function (as shown on FIG. 12); on the other hand, as long as the stop body portion 41 is removed from the space between the door plank 50 and the doorframe 70 (as dot-lines shown on FIG. 12), the anti finger pinch function of the invention is flexibly removed from the door, so that the door plank (window) 50 is able to be closed as appropriate. When the door needs to be re-opened, the invention is able to automatically perform the same anti finger pinch function by enabling the stop body portion to be sunk into the space between the door plank 50 and the doorframe 70 due to the elasticity of the elastic portion 424 on the rear side of the upright-angled arm 42 of the stop body portion 41, moreover, the invention has no the same drawback as prior art of easy loss of the door stop 40, with lower manufacturing cost and is suitable to be applied to those places with many young children (such as school, kindergarten, etc.).

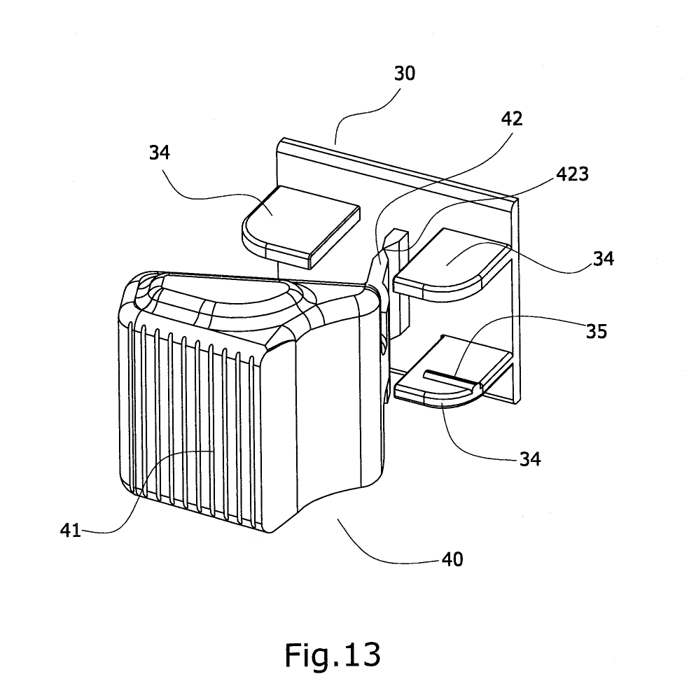

With reference to FIG. 13, another embodiment of the invention shows that the fixer 30 is made in a flat plane, having a pair of locating plates 34 respectively arranged both sides on the upper surface of the fixer 30, at least one of the locating plates 34 has an arresting portion 35 (a rib or raised portion) accommodated on the inner lateral side thereof, in addition, a door stop 40 (plastic injection molding) is formed on the central surface of the fixer 30, comprising a stop body portion 41 and a upright-angled arm 42; a bendable portion 423 (extremely slim connecting portion) is formed on the end of the upright-angled arm 42 near the surface of the fixer 30 to enable the door stop 40 to change position to the left or to the right.

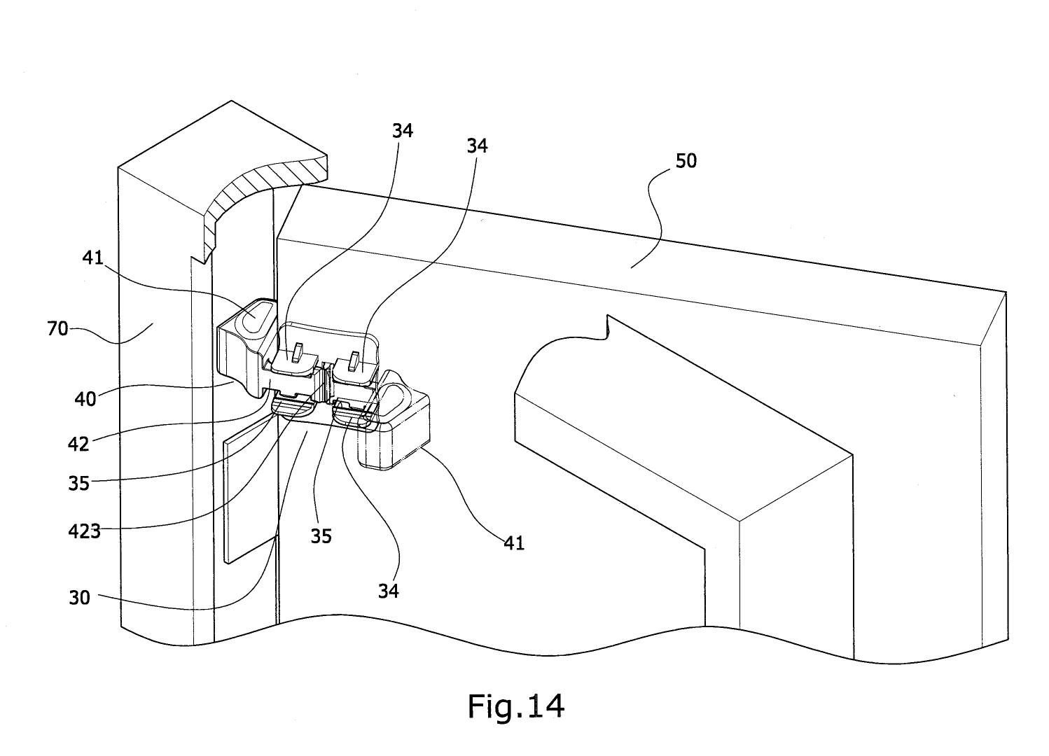

Upon application of the invention, the fixer 30 is fastened on a proper position on the rear edge of the door plank 50, the door stop 40 is placed on the left to enable the upright-angled arm 42 to be wedged in a pair of the locating plates 34 on the left by a arresting portion 35, so that the stop body portion 41 is sunk in the space between the rear edge of the door plank 50 and the doorframe 70 to perform the anti finger pinch function (as full lines shown on FIG. 14); when the door stop 40 is moved to the right, enabling the upright-angled arm 42 to be wedged in a pair of the locating plates 34 on the right by another arresting portion 35, the door is departed from the anti finger pinch function of the invention (as dot lines shown on FIG. 14), so that the door plank is completely closed.

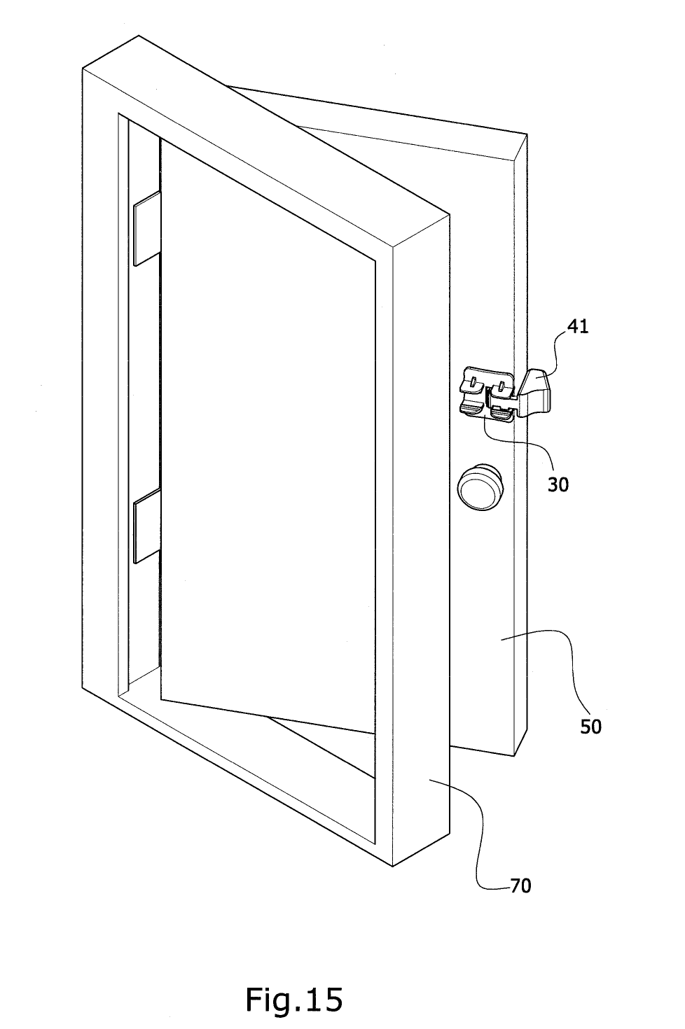

In addition to the forgoing embodiments of the invention, another embodiment of the invention on FIG. 15 shows that the fixer 30 is fastened on a proper position on the front edge of the door plank 50 (the lateral side near the door handle), when the stop body portion 41 is positioned between the front edge of the door plank 50 and the doorframe 70, the invention enables the door to be opened preventing a child from being locked inside a room without any adult company due to strong wind or pet behaviors.

In view of the forging, the “door or window safety mechanism” of the invention is a simple structure having the low manufacturing cost, easy installation and use and anti finger pinch advantages and effects. To sum up, the invention has the effects of practicability, innovation and advancement in the industry, and therefore, is disclosed herein.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A door or window safety mechanism, mainly comprising a fixer and a door stop; wherein:
the fixer, sandwiching a lateral side of a door plank or window; and
the door stop, comprising a stop body portion and a 90-degree bended upright-angled arm; wherein the end of the upright-angled arm and the fixer are fastened together for use and the end of the upright-angled arm is a pivot for changing the position of the stop body portion.

2. The door or window safety mechanism of claim 1, wherein the fixer is in an angular U shape.

3. The door or window safety mechanism of claim 1, wherein the fixer is a flat plate.

4. The door or window safety mechanism of claim 2, wherein the fixer on one lateral side thereof has a upright shaft accommodated parallel to the fixer; a locating plate is arranged on one lateral side of the upright shaft and a hole is arranged on the end of the upright-angled arm of the door stop to sleeve the upright shaft on the fixer for integration.

5. The door or window safety mechanism of claim 3, wherein the fixer has a round slot arranged on one lateral side thereof, the end of the upright-angled arm of the door stop has a globular portion arranged thereof to be accommodated in the round slot of the fixer for combination.

6. The door or window safety mechanism of claim 3, wherein the fixer has one lateral side thereof formed with the end of the upright-angled arm of the door stop in one piece, in addition, the upright-angled arm has a bendable elastic portion formed on the end thereof, enabling the stop body portion to be positioned on the rear lateral side of the fixer.

7. The door or window safety mechanism of claim 3, wherein the fixer has two pairs of locating plates respectively defined on both sides of the upper surface thereof, at least an arresting portion is positioned on the inner lateral side of one locating plate, the door stop is integrally formed on the central upper surface of the fixer, the upright-angled arm of the door stop has a bendable portion defined on the end near the fixer.

8. The door or window safety mechanism of claim 3, wherein the fixer on one lateral side thereof has a upright shaft accommodated parallel to the fixer; a locating plate is arranged on one lateral side of the upright shaft and a hole is arranged on the end of the upright-angled arm of the door stop to sleeve the upright shaft on the fixer for integration.
